(19) United States
(12) Patent Application Publication
(10) Pub. No.: US 2025/0227526 A1
(43) Pub. Date: Jul. 10, 2025

(54) COMMUNICATION METHOD, COMMUNICATION APPARATUS, MEDIUM, AND PROGRAM PRODUCT

(71) Applicant: HUAWEI TECHNOLOGIES CO., LTD., Shenzhen (CN)

(72) Inventors: Lei Dong, Shanghai (CN); Hao Tang, Shanghai (CN); Liqing Zhang, Ottawa (CA); Jianglei Ma, Ottawa (CA)

(73) Assignee: HUAWEI TECHNOLOGIES CO., LTD., Shenzhen (CN)

(21) Appl. No.: 19/091,544

(22) Filed: Mar. 26, 2025

Related U.S. Application Data
(63) Continuation of application No. PCT/CN2022/121766, filed on Sep. 27, 2022.

(51) Int. Cl. H04W 24/08; H04W 24/10

(52) U.S. Cl. CPC H04W 24/08; H04W 24/10

(57) ABSTRACT

A first communication apparatus measures a measurement signal to obtain a measurement result; and the first communication apparatus sends the measurement result and measurement time information to a second communication apparatus, where the measurement time information indicates a measurement time point or a measurement time window at which the first communication apparatus performs the measurement. In this manner, the first communication apparatus may report the measurement time information of the measurement result. Therefore, the measurement time information of the measurement result is provided.

### CROSS-REFERENCE TO RELATED APPLICATIONS

This application is a continuation of International Application No. PCT/CN2022/121766, filed on Sep. 27, 2022, the disclosure of which is hereby incorporated by reference in its entirety.

### TECHNICAL FIELD

This application relates to the communication field, and more specifically, to a communication method, a communication apparatus, a computer-readable storage medium, and a computer program product.

### BACKGROUND

With development of wireless communication technologies, currently, higher data transmission requirements such as a higher throughput, a lower latency, higher reliability, and a larger quantity of connections are imposed on a fifth-generation communication technology (5th Generation Mobile Communication Technology, 5G), that is, a new radio (New Radio, NR) system. A next-generation communication technology evolved after 5G may further integrate a communication network with a sensing network, a computing power network, and the like, to achieve higher transmission efficiency. The sensing network may implement functions such as target positioning (for example, ranging, speed measurement, or angle measurement), target imaging, target detection, or target recognition through sensing or measurement.

A current measurement result reporting mechanism is designed for a communication signal, and aims at determining channel quality by measuring the communication signal, to ensure communication quality. For example, a terminal device may report average communication quality of a cell to a network device. However, this measurement result reporting mechanism is not applicable to measurement and reporting of a sensing signal.

### SUMMARY

To resolve the foregoing problem, embodiments of this application provide a communication method for reporting a measurement result, a communication apparatus, a computer-readable storage medium, and a computer program product.

According to a first aspect, a communication method is provided. The method includes: A first communication apparatus measures a measurement signal to obtain a measurement result; and the first communication apparatus sends the measurement result and measurement time information to a second communication apparatus, where the measurement time information indicates a measurement time point or a measurement time window at which the first communication apparatus performs the measurement. In this manner, the first communication apparatus may report the measurement time information of the measurement result. Therefore, the measurement time information of the measurement result is provided, which helps the second communication apparatus obtain a measurement result with a time-domain correlation, and improves validity of the measurement result, thereby helping the second communication apparatus obtain a more complete measurement result. This is particularly beneficial in a scenario in which the first communication apparatus determines a measurement moment by itself.

In some implementations of the first aspect, the measurement time information includes at least one of a system frame number, a slot index, a mini-slot index, and a symbol index that correspond to the measurement time point. Therefore, this may help the second communication apparatus determine the measurement time point of the measurement result with fewer computing resources.

In some implementations of the first aspect, the measurement time information includes a time domain offset, and the time domain offset indicates a time interval between the measurement time point and a reference time point or a time interval between the measurement time window and a reference time point. In some implementations of the first aspect, the reference time point is a time point at which the first communication apparatus sends the measurement result or a time point at which the first communication apparatus sends the measurement time information. In this manner, the measurement time point or the measurement time window can be easily determined, and the measurement time information may be provided with lower signaling overheads.

In some implementations of the first aspect, the measurement time information indicates the measurement time point based on an index of the measurement signal. In some implementations of the first aspect, the index of the measurement signal includes at least one of the following: a window index, indicating a measurement signal window in which the measurement signal is located; a type index, indicating a type of the measurement signal; and a signal index, indicating a measurement signal in the measurement signal window in which the measurement signal is located or indicating a measurement signal of the type of the measurement signal or a signal in measurement signals in a predetermined time period. Therefore, the measurement time information may be reported with low communication resource overheads.

In some implementations of the first aspect, the measurement time information includes at least one of a start time point, an end time point, and duration that are of the measurement time window.

In some implementations of the first aspect, the measurement time information includes an index of the measurement time window. Thus, the measurement time window can be easily determined, and the measurement time information may be provided with lower signaling overheads.

In some implementations of the first aspect, the measurement result includes sensing information. Therefore, time-domain related information of a sensing measurement result may be provided.

According to a second aspect, a communication method is provided. For beneficial effect, refer to the description of the first aspect. Details are not described herein again. The method includes: A second communication apparatus receives a measurement result and measurement time information from a first communication apparatus, where the measurement result is obtained by the first communication apparatus by measuring a measurement signal, and the measurement time information indicates a measurement time point or a measurement time window for the measurement; and the second communication apparatus performs sensing processing or communication processing based on the measurement result and the measurement time information. Therefore, the second communication apparatus may determine, based on the measurement time information, a measurement moment corresponding to the measurement result, so that a measurement result with a time-domain correlation is obtained, and validity of the measurement result is improved, thereby helping the second communication apparatus obtain a more complete measurement result. This is particularly beneficial in a scenario in which the first communication apparatus determines a measurement moment by itself.

In some implementations of the second aspect, the measurement time information includes at least one of a system frame number, a slot index, a mini-slot index, and a symbol index that correspond to the measurement time point. In some implementations of the second aspect, the measurement time information includes a time domain offset, and the time domain offset indicates a time interval between the measurement time point and a reference time point or a time interval between the measurement time window and a reference time point. In some implementations of the second aspect, the reference time point is a time point at which the first communication apparatus sends the measurement result or a time point at which the first communication apparatus sends the measurement time information.

In some implementations of the second aspect, the measurement time information indicates the measurement time point based on an index of the measurement signal. In some implementations of the second aspect, the index of the measurement signal includes: a window index, indicating a measurement signal window in which the measurement signal is located; a type index, indicating a type of the measurement signal; and a signal index, indicating a measurement signal in the measurement signal window in which the measurement signal is located or indicating a reference signal of the type of the measurement signal or a signal in measurement signals in a predetermined time period.

In some implementations of the second aspect, the measurement time information includes at least one of a start time point, an end time point, and duration that are of the measurement time window. In some implementations of the second aspect, the measurement time information includes an index of the measurement time window. In some implementations of the second aspect, the measurement result includes sensing information.

According to a third aspect, a communication method is provided. The method includes: A first communication apparatus determines a first reporting time window; and the first communication apparatus sends a measurement result to a second communication apparatus in the first reporting time window, where the measurement result is obtained by the first communication apparatus by measuring a measurement signal. In this manner, the first communication apparatus may use the reporting time window when reporting the measurement result. Therefore, timeliness of the measurement result can be ensured, measurement result invalidity can be avoided, and validity of measurement effect can be improved.

In some implementations of the third aspect, the first reporting time window includes at least one of a start time point, an end time point, and duration. In some implementations of the third aspect, the start time point is a time point at which the first communication apparatus performs the measurement or a time point at which the first communication apparatus sends the first reporting time window. Therefore, it can be ensured that there is a correlation between a sensing measurement moment and a reporting moment, thereby ensuring timeliness of the measurement result.

In some implementations of the third aspect, the method further includes: The first communication apparatus sends the first reporting time window to the second communication apparatus. In some implementations of the third aspect, the first reporting time window is included in a buffer status report. In some implementations of the third aspect, the method further includes: The first communication apparatus receives, from the second communication apparatus, a resource for sending the measurement result, where the resource is in the first reporting time window. Therefore, the first communication apparatus indicates, to the second communication apparatus, the first reporting time window determined by the first communication apparatus, to assist the second communication apparatus in determining the resource for reporting the measurement result. The dynamically indicated reporting resource can further enhance timeliness of reporting the measurement result, avoid measurement result invalidity, and improve validity of measurement effect.

In some implementations of the third aspect, the method further includes: The first communication apparatus selects a preconfigured resource in the first reporting time window, to send the measurement result to the second communication apparatus. Therefore, timeliness of the measurement result can be ensured with low resource overheads.

In some implementations of the third aspect, that a first communication apparatus determines a first reporting time window includes: The first communication apparatus receives one or more reporting time windows determined by the second communication apparatus from the second communication apparatus, where the one or more reporting time windows includes the first reporting time window; and the first communication apparatus determines the first reporting time window from the one or more reporting time windows. In this manner, the first communication apparatus may determine, based on the reporting time window determined by the second communication apparatus, a reporting time window applicable to current measurement. In this way, the first communication apparatus may determine the reporting time window with fewer computing resources.

In some implementations of the third aspect, the method further includes: The first communication apparatus sends a reporting condition of the first reporting time window to the second communication apparatus, where the reporting condition includes at least one of the following: mobility of the first communication apparatus, a measurement environment, a type of the measurement result, and a value of the measurement result. Correspondingly, the second communication may determine the first reporting time window based on the reporting condition received from the first communication apparatus, to determine the resource for reporting the measurement result in the first reporting time window. Compared with direct sending of the reporting time window, sending of the reporting condition may occupy fewer communication resources. In this manner, the second communication apparatus may learn of the first reporting time window with low resource overheads, to assist the second communication apparatus in determining the resource for reporting the measurement result.

In some implementations of the third aspect, the first reporting time window is determined based on a reporting condition, and the reporting condition includes at least one of the following: mobility of the first communication apparatus, a measurement environment, a type of the measurement result, and a value of the measurement result. In this manner, the first reporting time window may be determined with fewer computing resources.

In some implementations of the third aspect, the measurement result includes sensing information. Therefore, timeliness of a sensing measurement result can be ensured.

According to a fourth aspect, a communication method is provided. For beneficial effect, refer to description of the third aspect. Details are not described herein again. The method includes: A second communication apparatus determines a first reporting time window; and the second communication apparatus receives a measurement result from a first communication apparatus in the first reporting time window, where the measurement result is obtained by the first communication apparatus by measuring a measurement signal.

In some implementations of the fourth aspect, that a second communication apparatus determines a first reporting time window includes: The second communication apparatus receives the first reporting time window from the first communication apparatus.

In some implementations of the fourth aspect, the first reporting time window is included in a buffer status report.

In some implementations of the fourth aspect, the first reporting time window includes at least one of a start time point, an end time point, and duration. In some implementations of the fourth aspect, the start time point is a time point at which the first communication apparatus performs the measurement or a time point at which the first communication apparatus sends the first reporting time window.

In some implementations of the fourth aspect, the method further includes: The second communication apparatus determines a resource used by the first communication apparatus for sending the measurement result, where the resource is in the first reporting time window; and the second communication apparatus sends an indication of the resource to the first communication apparatus.

In some implementations of the fourth aspect, that the second communication device receives a measurement result includes: The second communication apparatus receives the measurement result from the first communication apparatus by using a preconfigured resource in the first reporting time window.

In some implementations of the fourth aspect, the method further includes: The second communication apparatus determines one or more reporting time windows, where the one or more reporting time windows include the first reporting time window; and the second communication apparatus sends the one or more reporting time windows to the first communication apparatus.

In some implementations of the fourth aspect, that a second communication apparatus determines a first reporting time window includes: The second communication apparatus receives a reporting condition of the first reporting time window from the first communication apparatus; and the second communication apparatus determines the first reporting time window based on the reporting condition.

In some implementations of the fourth aspect, the first reporting time window is determined based on a reporting condition, and the reporting condition includes at least one of the following: mobility of the first communication apparatus, a measurement environment, a type of the measurement result, and a value of the measurement result. In some implementations of the fourth aspect, the measurement result includes sensing information.

According to a fifth aspect, a first communication apparatus is provided. The first communication apparatus includes a module or a unit configured to perform any method in any one of the first aspect or the third aspect and the implementations of the first aspect or the third aspect.

According to a sixth aspect, a second communication apparatus is provided. The second communication apparatus includes a module or a unit configured to perform any method in any one of the second aspect or the fourth aspect and the implementations of the second aspect or the fourth aspect.

According to a seventh aspect, a first communication apparatus is provided. The first communication apparatus includes a processor, the processor is coupled to a memory, the memory stores instructions, and when the instructions are executed by the processor, the first communication apparatus is enabled to perform any method in any one of the first aspect or the third aspect and the implementations of the first aspect or the third aspect.

According to an eighth aspect, a second communication apparatus is provided. The second communication apparatus includes a processor, the processor is coupled to a memory, the memory stores instructions, and when the instructions are executed by the processor, the second communication apparatus is enabled to perform any method in any one of the second aspect or the fourth aspect and the implementations of the second aspect or the fourth aspect.

According to a ninth aspect, a computer-readable storage medium is provided. The computer-readable storage medium stores instructions, and when the instructions are run, the method in any one of the first aspect or the third aspect or the implementations of the first aspect or the third aspect is performed.

According to a tenth aspect, a computer-readable storage medium is provided. The computer-readable storage medium stores instructions, and when the instructions are run, the method in any one of the second aspect or the fourth aspect or the implementations of the second aspect or the fourth aspect is performed.

According to an eleventh aspect, a computer program product is provided. The computer program product includes instructions, and when the instructions are run, the method in any one of the first aspect or the third aspect or the implementations of the first aspect or the third aspect is performed.

According to a twelfth aspect, a computer program product is provided. The computer program product includes instructions, and when the instructions are run, the method in any one of the second aspect or the fourth aspect or the implementations of the second aspect or the fourth aspect is performed.

According to a thirteenth aspect, a communication system is provided. The communication system includes the first communication apparatus according to the fifth aspect or the seventh aspect and the second communication apparatus according to the sixth aspect or the eighth aspect.

### BRIEF DESCRIPTION OF DRAWINGS

The foregoing and other features, advantages, and aspects of embodiments of this application become clearer with reference to accompanying drawings and the following detailed descriptions. In the accompanying drawings, same or similar reference numerals indicate same or similar elements.

FIG. 1 is a diagram of a scenario of NR protocol-based aperiodic measurement and reporting;

FIG. 2 is a diagram of a communication system to which an embodiment of this application is applicable;

FIG. 3 is an interaction signaling diagram of a method for reporting a measurement result according to an embodiment of this application;

FIG. 4A and FIG. 4B are diagrams of example implementations of measurement time information according to an embodiment of this application;

FIG. 5 is an interaction signaling diagram of a method for reporting a measurement result according to an embodiment of this application;

FIG. 6 is a diagram of an example implementation of reporting a measurement result based on a dynamically indicated resource in a reporting time window according to an embodiment of this application;

FIG. 7 is a schematic flowchart of a method implemented by a first communication apparatus according to an embodiment of this application;

FIG. 8 is a schematic flowchart of a method implemented by a second communication apparatus according to an embodiment of this application;

FIG. 9 is a schematic flowchart of a method implemented by a first communication apparatus according to an embodiment of this application;

FIG. 10 is a schematic flowchart of a method implemented by a second communication apparatus according to an embodiment of this application; and

FIG. 11 is a block diagram of an example device that may be configured to implement an embodiment of this application.

### DESCRIPTION OF EMBODIMENTS

The following describes embodiments of this application in more detail with reference to the accompanying drawings. Although some embodiments of this application are shown in the accompanying drawings, it should be understood that this application may be implemented in various forms, and should not be construed as being limited to embodiments described herein. On the contrary, these embodiments are provided for a more thorough and complete understanding of this application. It should be understood that the accompanying drawings and embodiments of this application are only used as examples, but are not intended to limit the protection scope of this application.

In the descriptions of embodiments of this application, the term “include” and similar terms thereof should be understood as open inclusion, that is, “include but not limited to”. The term “based on” should be understood as “at least partially based on”. The term “one embodiment” or “this embodiment” should be understood as “at least one embodiment”. The terms “first”, “second”, and the like may indicate different objects or a same object. Other explicit and implicit definitions may also be included below.

Embodiments of this application may be implemented according to any proper communication protocol, including but not limited to a cellular communication protocol, for example, a fourth generation (4th generation, 4G), a fifth generation (5th generation, 5G), and a communication protocol evolved after 5G (for example, a sixth generation (6th generation, 6G)), a wireless local area network communication protocol, for example, institute of electrical and electronics engineers (Institute of Electrical and Electronics Engineers, IEEE) 802.11, and/or any other protocol known or developed in the future.

The technical solutions in embodiments of this application are applied to a communication system that complies with any proper communication protocol, for example, a long term evolution (Long Term Evolution, LTE) system, a frequency division duplex (Frequency Division Duplex, FDD) system, a time division duplex (Time Division Duplex, TDD) system, a 5G system (for example, NR), and a communication system evolved after 5G (for example, a 6G system).

For the purpose of description, the following describes embodiments of this application in a background of a cellular communication system in the 3rd generation partnership project (3rd Generation Partnership Project, 3GPP). However, it should be understood that embodiments of this application are not limited to the communication system, but may be applied to any communication system having a similar problem, for example, a wireless local area network (Wireless Local Area Network, WLAN), a wired communication system, or another communication system developed in the future.

The term “terminal device” used in this application refers to any terminal device that can perform wired or wireless communication with a network device or between terminal devices. The terminal device may be sometimes referred to as user equipment (User Equipment, UE). The terminal device may be any type of mobile terminal, fixed terminal, or portable terminal. The terminal device may be various wireless communication devices that have a wireless communication function. With emergence of an internet of things (Internet of Things, IOT) technology, more devices that previously have no communication function, for example without limitation to, a household appliance, a transportation tool, a tool device, a service device, and a service facility, start to obtain a wireless communication function by being configured with a wireless communication unit, so as to access a wireless communication network, and accept remote control. Such a device has the wireless communication function because the device is configured with the wireless communication unit, and therefore also belongs to a scope of wireless communication devices. For example, the terminal device may include a mobile cellular phone, a cordless phone, a mobile terminal (Mobile Terminal, MT), a mobile station, a mobile device, a wireless terminal, a handheld device, a client, a subscription station, a portable subscription station, an internet node, a communicator, a desktop computer, a laptop computer, a notebook computer, a tablet computer, a personal communication system device, a personal navigation device, a personal digital assistant (Personal Digital Assistant, PDA), customer-premises equipment (customer-premises equipment, CPE), a smart point of sale (point of sale, POS) machine, a wireless data card, a wireless modem (Modulator demodulator, Modem), a positioning device, a radio broadcast receiver, an e-book device, a game device, an IoT device, an in-vehicle device, an airplane, a virtual reality (Virtual Reality, VR) device, an augmented reality (Augmented Reality, AR) device, a wearable device (for example, a smartwatch), a terminal in device-to-device (device-to-device, D2D) communication, a terminal in vehicle to everything (vehicle to everything, V2X), a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a terminal device in a 5G network or any terminal device in an evolved public land mobile network (Public Land Mobile Network, PLMN), another device that can be used for communication, or any combination thereof. This is not limited in embodiments of this application.

The term “network device” used in this application is an entity or a node that may be configured to communicate with a terminal device, for example, may be an access network device. The access network device may be an apparatus that is deployed in a radio access network and that provides a wireless communication function for a mobile terminal. For example, the access network device may be a radio access network (Radio Access Network, RAN) network device. The access network device may include various types of base stations. The base station is configured to provide a wireless access service for the terminal device. Depending on a size of a provided service coverage area, the access network device may include a macro base station providing a macro cell (Macro cell), a micro base station providing a micro cell (Pico cell), a pico base station providing a pico cell, and a femto base station providing a femto cell (Femto cell). In addition, the access network device may further include various forms of relay stations, access points, remote radio units (Remote Radio Unit, RRU), radio heads (Radio Head, RH), remote radio heads (Remote Radio Head, RRH), transmission reception points (transmitting and receiving point, TRP), transmission points (transmitting point, TP), and the like. In systems using different radio access technologies, the access network device may have different names. For example, the access network device is referred to as an evolved NodeB (evolved NodeB, eNB or eNodeB) in an LTE network, is referred to as a NodeB (NodeB, NB) in a 3G network, and may be referred to as a g NodeB (gNB) or an NR NodeB (NR NB) in a 5G network. In some scenarios, the access network device may include a central unit (Central Unit, CU) and/or a distributed unit (Distributed Unit, DU). The CU and the DU may be deployed in different places. For example, the DU is remotely deployed in a high-traffic area, and the CU is deployed in a central equipment room. Alternatively, the CU and the DU may be deployed in a same equipment room. Alternatively, the CU and the DU may be different components at a same rack. The network device may also be a device that undertakes a base station function in device-to-device (Device-to-Device, D2D), vehicle-to-everything (vehicle-to-everything, V2X), or machine-to-machine (machine-to-machine, M2M) communication, or the like. For ease of description, in subsequent embodiments of this application, the foregoing apparatuses that provide the wireless communication function for the mobile terminal are collectively referred to as a network device. This is not specifically limited in embodiments of this application.

With development of wireless communication technologies, currently, higher data transmission requirements such as a higher throughput, a lower latency, higher reliability, and a larger quantity of connections are imposed on a 5G NR system. A next-generation communication technology evolved after 5G may further integrate a communication network with a sensing network, a computing power network, and the like, to achieve higher transmission efficiency. The sensing network may implement functions such as target positioning (for example, ranging, speed measurement, or angle measurement), target imaging, target detection, or target recognition through sensing or measurement.

In the current 5G NR system, to obtain channel state information (channel state information, CSI), a network device usually first configures a resource for transmitting a CSI-reference signal (CSI-RS reference signal, CSI-RS) to a terminal device, and then transmits the CSI-RS on the resource. The terminal device receives the CSI-RS on the resource, determines various types of CSI according to a predetermined rule, and reports the CSI on a preconfigured resource. The various types of CSI may include a channel quality indicator (channel quality indicator, CQI), a precoding matrix indicator (precoding matrix indicator, PMI), a CSI-RS resource indicator (CSI-RS resource indicator, CRI), an SS/PBCH block indicator (SS/PBCH block resource indicator, SSBRI), a layer indicator (layer indicator, LI), a rank indicator (rank indication, RI), an L1 reference signal received power (layer 1 reference signal received power, L1-RSRP), and the like. The CSI may be periodically, semi-persistently, or aperiodically measured and reported. Resources for transmitting the CSI-RS one-to-one correspond to resources for reporting the CSI.

For example, when the CSI is periodically measured and reported, the network device first configures a periodic first resource and a periodic second resource through radio resource control (radio resource control, RRC), to transmit the CSI-RS and report the CSI respectively. First resources for transmitting the CSI-RS one-to-one correspond to second resources for reporting the CSI. Then, the network device periodically sends the CSI-RS on the configured first resource, and the terminal device periodically reports the CSI on the configured second resource. Alternatively, when the CSI is semi-persistently measured and reported, the network device first configures a periodic first resource and a periodic second resource through RRC, to transmit the CSI-RS and report the CSI respectively. First resources for transmitting the CSI-RS one-to-one correspond to second resources for reporting the CSI. Then, the network device activates semi-persistent CSI-RS transmission via a MAC CE-1, and then the network device sends the CSI-RS on the configured first resource. Next, the network device activates semi-persistent CSI reporting via a MAC CE-2, and then the terminal device reports the CSI on the configured second resource. Alternatively, when the CSI is aperiodically measured and reported, the network device first triggers CSI-RS transmission and CSI reporting by using downlink control information (downlink control information, DCI). Resources for transmitting the CSI-RS one-to-one correspond to resources for reporting the CSI.

FIG. 1 is a diagram of a scenario of NR-based aperiodic measurement and reporting. As shown in FIG. 1, based on DCI received from a network device at a moment t1, a terminal device may determine that a time domain offset between a transmission moment of the CSI-RS and the transmission moment t1 of the DCI is Offset #X, and a time domain offset between a reporting moment of CSI and the transmission moment t1 of the DCI is Offset #Y. The terminal device further determines a transmission moment t2 of the CSI-RS and a reporting moment t3 of CSI. The two are in a one-to-one correspondence. In these cases, when reporting the CSI, the terminal device does not need to additionally indicate a corresponding resource for transmitting the CSI-RS, because the network device may determine, based on a resource for reporting the CSI, the corresponding resource for transmitting the CSI-RS. In addition, in a radio resource management (radio resource management, RRM) technology in the NR system, the terminal device may determine average communication quality of a cell based on a long-term measurement result of a beam. Because the average communication quality of the cell is a long-term measurement result based on a plurality of beams, when reporting the measured average communication quality, the terminal device does not need to report a beam based on which the measurement result is obtained. The network device may determine a corresponding beam based on a resource for reporting the average communication quality. In other words, in a process in which the terminal device receives a signal to perform measurement and report the measurement result, a receiving resource one-to-one corresponds to a reporting resource. Therefore, when reporting the measurement result to the network device, the terminal device does not need to report a signal or a beam based on which the measurement result is measured, so that the network device can learn of time-domain related information of the measurement result based on the reporting resource of the measurement result, and perform communication processing based on the measurement result.

With the development of communication technologies, research related to a sensing technology has been carried out. The sensing technology creates a new application scenario that covers a series of use cases, such as device-based or even deviceless target positioning, imaging, environment reconstruction and monitoring, and gesture and activity recognition. The sensing technology adds new performance dimensions to the research of a global mobile communication system, such as accuracy detection, resolution sensing, and accuracy sensing (including a distance, a speed, and an angle). Performance requirements of these dimensions vary according to applications. In some sensing technology research, to further reduce transmission overheads, the terminal device may reuse an existing signal (for example, a reference signal (such as a CSI-RS) or a synchronization signal (such as a synchronization signal block (Synchronization Signal Block, SSB))) to perform sensing measurement. For example, the network device may send the CSI-RS to the terminal device, and the terminal device may receive the CSI-RS, and measure and report the CSI. In addition to measuring channel information in the existing 5G technology, the CSI-RS may be further used to measure sensing information. Due to a dynamic change of a sensing environment, whether the existing reference signal or the synchronization signal is used to measure the sensing information and when to use which reference signal or synchronization signal to measure the sensing information may be determined by the terminal device. However, when the terminal device itself determines to reuse a part of existing signals to perform the sensing measurement, the network device cannot learn of, based on the sensing measurement result, a signal or a beam based on which the sensing measurement result is measured. When the network device cannot learn of the time-domain related information of the sensing measurement result, the sensing measurement result may be unavailable for the network device.

Currently, there is no effective solution to enable the network device to learn of the time-domain related information of the sensing measurement result. For example, the network device may need to obtain a sensing measurement result of a channel changing over time. If the terminal device does not report that the sensing measurement result is measured based on a reference signal at which previous moment, the network device cannot obtain information about the channel changing over time. Although the foregoing analysis is performed for the sensing technology scenario, the same or similar problem may generally exist in a scenario in which any communication device sends a measurement result to another communication device after measuring a measurement signal.

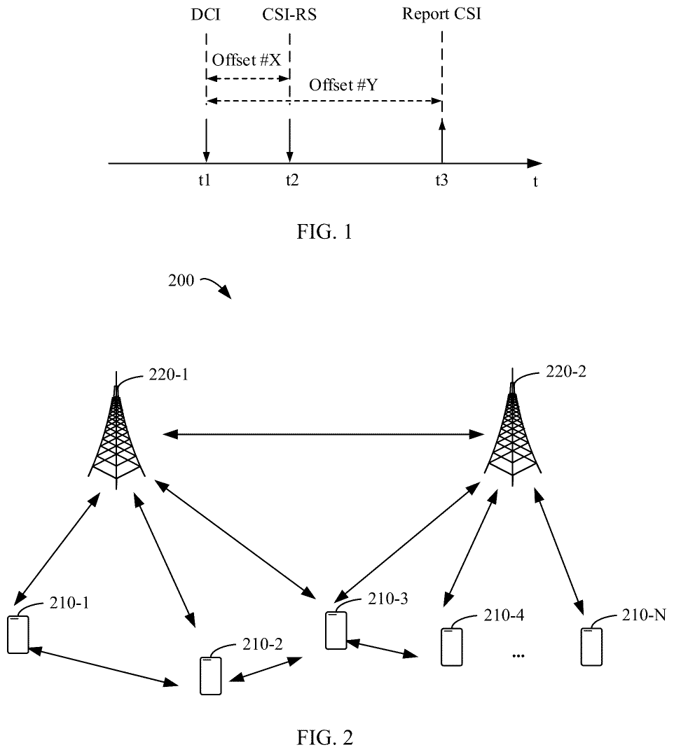

To resolve the foregoing problem, an embodiment disclosed in this application provides a communication method for reporting a measurement result. In the method, a first communication apparatus (for example, a terminal device) measures a measurement signal to obtain a measurement result. Further, the first communication apparatus sends a measurement result and measurement time information to a second communication apparatus (for example, a network device), where the measurement time information indicates a measurement time point or a measurement time window at which the first communication apparatus performs the measurement. In the foregoing manner, the second communication apparatus can determine, based on the measurement time information, a measurement time point or a measurement time window corresponding to the measurement result, to determine the measurement signal. In this manner, the second communication apparatus can obtain a measurement result with a time-domain correlation, thereby improving validity of the measurement result, and helping obtain a complete and available measurement result. The foregoing embodiments disclosed in this application may be applicable to any other communication scenario. This is not limited thereto. To discuss embodiments disclosed in this application more clearly, embodiments disclosed in this application are described with reference to FIG. 2 to FIG. 11.

FIG. 2 is a diagram of a communication system 200 to which an embodiment of this application is applicable. As shown in FIG. 2, the system 200 may include terminal devices 210-1 to 210-N (collectively referred to as a terminal device 210) and network devices 220-1 and 220-2 (collectively referred to as a network device 220). The network device 220 may directly communicate with the terminal device 210. For example, the terminal device 210 may communicate with the corresponding network device 220 over a radio link. Alternatively or additionally, the network devices 220 may directly communicate with each other. For example, the network devices 220 may communicate with each other over a backhaul (backhaul) link. The backhaul link may be a wired backhaul link (for example, an optical fiber or a copper cable), or may be a wireless backhaul link (for example, a microwave). Alternatively or additionally, the terminal devices 210 may directly communicate with each other.

It should be understood that quantities of terminal devices and network devices shown in FIG. 2 are merely used as examples. There may be more or fewer terminal devices and network devices. This is not limited in this application. In the following, the terminal device may also be referred to as a first communication apparatus or may include a first communication apparatus, and the network device may also be referred to as a second communication apparatus or may include a second communication apparatus. Some embodiments in the following describe communication between the first communication apparatus and the second communication apparatus. It should be understood that the communication is not limited to occurring between the terminal device and the network device, and may also occur between terminal devices, between network devices, or between any two or more communication devices in some scenarios.

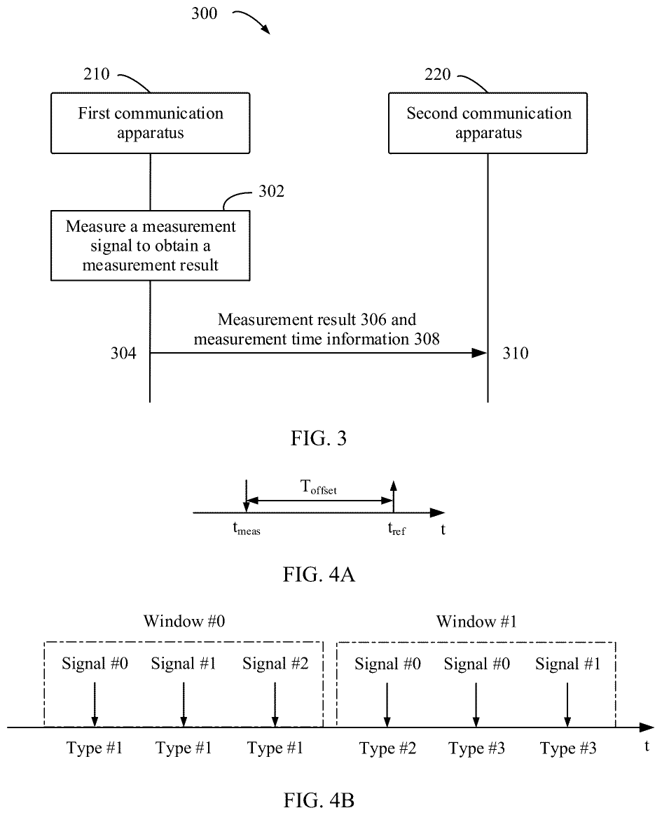

FIG. 3 is an interaction signaling diagram of a method 300 for reporting a measurement result according to an embodiment of this application. For clarity of discussion, the method 300 is discussed with reference to FIG. 2. The method 300 includes:

302: A first communication apparatus 210 measures a measurement signal to obtain a measurement result.

In some implementations, the measurement signal may be a measurement signal received by the first communication apparatus 210 from another communication apparatus. The another communication apparatus may be a second communication apparatus 220 or another communication apparatus that needs to receive the measurement result. In another implementation, the measurement signal may be a measurement signal received by the first communication apparatus 210 from the first communication apparatus 210.

304: The first communication apparatus 210 sends the measurement result 306 and measurement time information 308 to the second communication apparatus 220.

310: The second communication apparatus 220 receives the measurement result 306 and the measurement time information 308 from the first communication apparatus 210.

The measurement result 306 and the measurement time information 308 may be sent and received at the same time, or may be sent and received separately at different moments. The measurement time information 308 indicates a measurement time point or a measurement time window at which the first communication apparatus 210 performs the measurement. A person skilled in the art may understand that there may be a correspondence between a time at which the first communication apparatus 210 receives the measurement signal to perform the measurement and a time at which the measurement signal is sent. In some implementations, the measurement time information 308 may indicate, by indicating a sending time point or a sending time window at which the measurement signal is sent, the measurement time point or the measurement time window at which the first communication apparatus 210 performs the measurement.

Generally, the first communication apparatus 210 may provide measurement time information in any proper form, so that the second communication apparatus 220 may determine the measurement time point or the measurement time window.

In a possible implementation, the measurement time information indicates the measurement time point, and the measurement time information may include at least one of a system frame number, a slot index, a mini-slot index, and a symbol index that correspond to the measurement time point. For example, the first communication apparatus 210 may perform sensing measurement by using a sensing signal, and determine a sensing measurement moment and a reporting moment by itself. The sensing signal may be a part or all of reference signals in an NR protocol, or may be a newly defined signal. When the first communication apparatus 210 reports a sensing measurement result, the first communication apparatus 210 may directly indicate a specific sensing measurement moment corresponding to the sensing measurement result, for example, a system frame number, a slot index, a mini-slot index, and a symbol index that correspond to the sensing measurement moment.

In another possible implementation, the measurement time information may include a time domain offset, and the time domain offset indicates a time interval between the measurement time point and a reference time point or a time interval between the measurement time window and a reference time point. For example, if the first communication apparatus 210 measures the measurement signal at a measurement time point, the time domain offset included in the measurement time information may include a time interval between the measurement time point and a reference time point. If the first communication apparatus 210 measures the measurement signal in a measurement time window, the time domain offset included in the measurement time information may include a time interval between a start moment of the measurement time window and a reference time point and/or a time interval between an end moment of the measurement time window and a reference time point. The reference time point may be a time point at which the first communication apparatus 210 sends the measurement result or a time point at which the first communication apparatus 210 sends the measurement time information. Optionally, the reference time point may be another reference time point known to both the first communication apparatus 210 and the second communication apparatus 220. The measurement time information may further include a length of the measurement time window. In some implementations, a unit of the time domain offset or the measurement time window may include at least one of a slot, a symbol, a mini-slot, a subframe, a second, a millisecond, and the like.

Now refer to FIG. 4A. A diagram of an example implementation of measurement time information is described as an example. The first communication apparatus 210 performs sensing measurement on a reference signal at a moment tₘₑₐₛ to obtain a sensing measurement result, and reports the sensing measurement result at a moment t_{ref}. The first communication apparatus 210 may report a time domain offset T_{offset} between the sensing measurement moment tₘₑₐₛ and the reference moment t_{ref}, where a reporting moment of the sensing measurement result is used as the reference moment t_{ref}. A unit of the time domain offset T_{offset} may be at least one of a slot, a symbol, a mini-slot, a subframe, a second, a millisecond, or the like.

Back to FIG. 3, in some implementations, the measurement time information may indicate the measurement time point based on an index of the measurement signal. In some implementations, the index of the measurement signal may be arranged in any proper manner, so that the index may be used to distinguish measurement signals received by the first communication apparatus 210 at different time points. For example, the second communication apparatus 220 may preconfigure a correspondence between the index of the measurement signal and the measurement time point. Optionally, the index of the measurement signal and the measurement time point may be further specified in a protocol. In this way, the first communication apparatus 210 may indicate the measurement time point to the second communication apparatus 220 by sending the index of the measurement signal. The index of the measurement signal may include a window index, a type index, a signal index, other indexes, and any combination of these different indexes. The window index may indicate a measurement signal window in which the measurement signal is located. The type index may indicate a type of the measurement signal. The signal index may indicate a measurement signal in the measurement signal window in which the measurement signal is located or indicate a measurement signal of the type of the measurement signal or a signal in measurement signals in a predetermined time period. For example, the signal index may indicate a number index of one of a plurality of measurement signals sent by the second communication apparatus 220 to the first communication apparatus 210 from a time point. In another example, the signal index may indicate a number index of one of a plurality of measurement signals sent by the second communication apparatus 220 to a plurality of terminal devices including the first communication apparatus 210 in a predetermined time period in which a time point at which the measurement result is reported is a deadline.

Generally, the measurement signal in this specification may be any signal that can be measured. For example, the measurement signal may be a synchronization signal, and the synchronization signal may include a synchronization signal block. In some implementations, the synchronization signal block may include a primary synchronization signal, a secondary synchronization signal, and a physical layer broadcast channel. For example, the first communication apparatus 210 may reuse an SSB as a sensing measurement signal to perform sensing measurement. The second communication apparatus 220 sends an SSB signal in a form of an SSB burst set. Each SSB burst set may be considered as an SSB burst window. The second communication apparatus 220 may preconfigure a length of the SSB burst window, one SSB burst window may include a plurality of SSB resources, and the second communication apparatus 220 may periodically and repeatedly send a plurality of SSB burst windows. When reporting the sensing measurement result for the SSB, the first communication apparatus 210 may further report a synchronization signal index. The synchronization signal index includes an SSB burst window index and an SSB resource index. The SSB burst window index indicates an SSB burst window in which the measured SSB is located, and the SSB resource index indicates an SSB resource that is in the SSB burst window and that is used to send the SSB. In other words, the measurement time information may be indicated by the SSB burst window index and the SSB resource index. In another implementation, the SSB resource may alternatively not be in the SSB burst window.

For example, the measurement signal may be a reference signal, and the first communication apparatus 210 may reuse a plurality of reference signals as sensing measurement signals to perform sensing measurement. A plurality of types of reference signals may be sent in a form of a reference signal window, and each reference signal window may include one or more types of reference signals. A plurality of types of reference signals may be the CSI-RS, the SSB, a demodulation reference signal (DMRS, demodulation reference signal), a channel sounding reference signal (sounding reference signal, SRS), a newly defined sensing signal, or the like. For reference signals of a same type, a same reference signal window may include one or more reference signals of the type. For example, one reference signal window may include (a plurality of) CSI-RSs. Optionally or additionally, one reference signal window may include (a plurality of) CSI-RSs and (a plurality of) SSBs. Now refer to FIG. 4B. A diagram of another example implementation of measurement time information is described as an example. The first communication apparatus 210 may reuse at least one of a reference signal of a type #1, a reference signal of a type #2, and a reference signal of a type #3 as sensing measurement signals to perform sensing measurement. The first communication apparatus 210 receives reference signals in a reference signal window #0 and a reference signal window #1. The first communication apparatus 210 may report a sensing measurement moment in a form of {a reference signal window index; a reference signal type index; a reference signal index}, where the reference signal index indicates one reference signal of a reference signal type in a reference signal window. For example, the reference signals shown in FIG. 4B may be separately indicated by {0; 1; 0} {0; 1; 1} {0; 1; 2} {1; 2; 0} {1; 3; 0} {1; 3; 1}.

Back to FIG. 3, with respect to the measurement time information, as mentioned above, the first communication apparatus 210 may provide measurement time information in any proper form, so that the second communication apparatus 220 may determine a measurement time point or a measurement time window. When the measurement time information indicates the measurement time window, in some implementations, the measurement time information may include a start time point, an end time point, duration, or any combination thereof of the measurement time window. For example, the first communication apparatus 210 may continuously perform measurement in a segment of measurement time window to obtain sensing information such as a Doppler shift. The first communication apparatus 210 may directly indicate the start moment and the end moment that are of the measurement time window, and report sensing measurement time information. Optionally, the first communication apparatus 210 may indicate the start moment and the duration that are of the measurement time window. Optionally, the first communication apparatus 210 may indicate the end moment and the duration that are of the measurement window.

In some implementations, the measurement time information may include an index of the measurement time window. For example, the index of the measurement time window may be arranged in any proper manner, so that the index may be used to distinguish between different measurement time windows. For example, the second communication apparatus 220 may preconfigure a correspondence between the index of the measurement time window and a measurement time window corresponding to the measurement signal. Optionally, the correspondence between the index of the measurement time window and the measurement time window corresponding to the measurement signal may alternatively be specified in a protocol. In this way, the first communication apparatus 210 may indicate the measurement time window to the second communication apparatus 220 by sending the index of the measurement time window. For example, the second communication apparatus 220 may preconfigure the index of the measurement time window, and the first communication apparatus 210 may report an index of the measurement time window corresponding to the measurement result.

In some implementations, the measurement result may include sensing information. For example, the first communication apparatus 210 may implement sensing functions such as positioning, detection, imaging, and identification of a surrounding target by measuring a radio signal, to obtain surrounding physical environment information. In another embodiment, the measurement result may also include any other measurement result obtained by measuring the measurement signal.

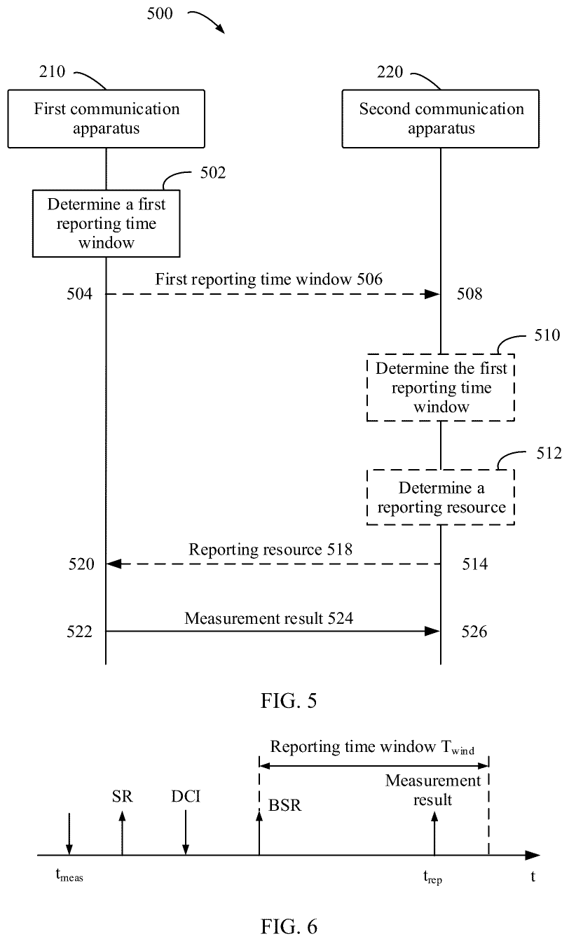

In addition, in some scenarios, a new mechanism is further required to ensure timeliness of the measurement result obtained by the first communication apparatus 210. FIG. 5 is an interaction signaling diagram of a method 500 for reporting a measurement result according to an embodiment of this application. The method 500 is described with reference to FIG. 2. The method 500 is specifically as follows:

502: A first communication apparatus 210 determines a first reporting time window 506.

In some implementations, the first communication apparatus 210 may determine the first reporting time window 506 by itself. For example, the first communication apparatus 210 may determine, based on mobility of the first communication apparatus 210, a measurement environment, a type of the measurement result, a value of the measurement result, or any combination of these conditions, the first reporting time window 506 applicable to current measurement.

In some implementations, the first communication apparatus may determine the first reporting time window 506 based on one or more reporting time windows determined by the second communication apparatus. For example, a second communication apparatus 220 may determine one or more reporting time windows, and the one or more reporting time windows include the first reporting time window 506. To determine (502) the first reporting time window 506, the first communication apparatus 210 may receive the one or more reporting time windows from the second communication apparatus 220, and determine the first reporting time window 506 from the one or more reporting time windows.

In some implementations, the one or more reporting time windows may be associated with a corresponding reporting condition. In general, the reporting condition may include any condition or factor that may affect determining of the reporting time window. For example, the reporting condition may include mobility of the first communication apparatus 210, a measurement environment, a type of the measurement result, a value of the measurement result, and any combination of these conditions. When the reporting time window is associated with the corresponding reporting condition, the first reporting time window 506 may be determined based on a reporting condition corresponding to the first reporting time window 506. The first communication apparatus 210 may send, to the second communication apparatus 220, the reporting condition corresponding to the first reporting time window 506. Correspondingly, the second communication apparatus 220 may receive, from the first communication apparatus 210, the reporting condition corresponding to the first reporting time window 506, and determine the first reporting time window 506 based on the reporting condition.

522: The first communication apparatus 210 sends a measurement result 524 to the second communication apparatus 220 in the first reporting time window 506, where the measurement result 524 is obtained by the first communication apparatus 210 by measuring a measurement signal.

526: The second communication apparatus 220 receives the measurement result 524 from the first communication apparatus 210 in the first reporting time window 506.

In the context of this application, the “reporting time window” and a “reporting delay window” may be used interchangeably.

For example, when the first communication apparatus 210 determines a sensing measurement moment by itself, to ensure timeliness of a sensing measurement result, the first communication apparatus 210 reports the sensing measurement result in a time range after the sensing measurement moment; otherwise, the sensing measurement result may be invalid. In some implementations, if the first communication apparatus 210 has not obtained a complete sensing measurement result in the time range due to factors such as a processing capability of the first communication apparatus 210, the first communication apparatus 210 may not report the sensing measurement result to the second communication apparatus 220, and the first communication apparatus 210 may clear an obtained part of sensing measurement results.

In some implementations, the first communication apparatus 210 may send (504) the first reporting time window 506 to the second communication apparatus 220. In some implementations, the second communication apparatus 220 may receive (508) the first reporting time window 506 from the first communication apparatus 210, to determine (510) the first reporting time window 506. In this manner, the second communication apparatus 220 may be assisted in determining a reporting resource that meets a timeliness requirement. Specifically, the first communication apparatus 210 may increase the first reporting time window 506 to existing information, or may send the first reporting time window 506 through a new message specially used to send the first reporting time window 506. For example, the first reporting time window 506 may be included in a buffer status report (buffer status report, BSR).

In some implementations, the first communication apparatus 210 may indicate the first reporting time window 506 in any proper manner, so that the second communication apparatus 220 can determine the first reporting time window 506. For example, the first reporting time window 506 may include one or any combination of a start time point, an end time period, and duration. In some implementations, the start time point of the first reporting time window 506 may be a time point at which the first communication apparatus 210 performs measurement. Optionally, the start time point of the first reporting time window may be a time point at which the first communication apparatus 210 sends the first reporting time window to the second communication apparatus 220.

In some possible implementations, the second communication apparatus 220 may determine (512) a reporting resource 518 used by the first communication apparatus 210 to send the measurement result, where the reporting resource 518 is in the first reporting time window 506. The second communication apparatus 220 may send (514) an indication of the reporting resource 518 to the first communication apparatus 210. The first communication apparatus 210 may receive (520) the indication of the resource 518 to send the measurement result 524 by using the reporting resource 518.

For example, the first communication apparatus 210 may report the sensing measurement result by using a resource dynamically indicated by the second communication apparatus 220. The first communication apparatus 210 sends a resource request to the second communication apparatus 220, where the resource request is used to request the resource for reporting the sensing measurement result, and the resource request may include a sensing reporting delay window, and is used to assist the second communication apparatus 220 in determining the resource for reporting the sensing measurement result, so as to meet a timeliness requirement of the sensing measurement result. In this scenario, a start position of the sensing reporting delay window may be a moment at which the first communication apparatus 210 sends the resource request to the second communication apparatus 220.

It may be understood that, in an embodiment, the first communication apparatus 210 may report the measurement result 306 or 524 with reference to the method 300 and the method 500. For example, the first communication apparatus 210 may determine, by using the method 500, a reporting resource required for sending (304) the measurement result 306 and the measurement time information 308 by the first communication apparatus 210 to the second communication apparatus 200 in the method 300, to ensure timeliness of the measurement result 306. Alternatively, the first communication apparatus 210 may report, by using the method 300, measurement time information corresponding to the measurement result 524 while reporting the measurement result 524.

Now refer to FIG. 6. An example implementation of reporting a measurement result based on a dynamically indicated resource in a reporting time window is described as an example. The first communication apparatus 210 may perform measurement at a moment tₘₑₐₛ. The first communication apparatus 210 sends a resource request to the second communication apparatus 220. For example, the resource request is a scheduling request (scheduling request, SR). After receiving the SR, the second communication apparatus 220 sends an indication of a reporting resource to the first communication apparatus 210. For example, the indication of the reporting resource is sent through DCI. Then, the first communication apparatus 210 sends a measurement result on the resource indicated by the DCI. For example, the measurement result may be included in a BSR.

It should be understood that, in this example, the BSR is triggered by the SR only for example description, and is not intended to be limited. Sending of the BSR may be triggered in another manner. A reporting time window T_{wind} determined by the first communication apparatus 210 may be included in the BSR. In some implementations, a start point of the reporting time window T_{wind} may be a sending moment of the BSR. In other embodiments, the start point of the reporting time window T_{wind} may be tₘₑₐₛ. The second communication apparatus 220 may determine, in the reporting time window T_{wind}, a resource used by the first communication apparatus 210 for sending the measurement result. For example, the time domain resource may be determined as tᵣₑₚ in the reporting time window T_{wind}. Therefore, the first communication apparatus 210 reports the measurement result at the moment tᵣₑₚ. In some implementations, if the first communication apparatus 210 has not obtained a complete measurement result at the moment tᵣₑₚ, the first communication apparatus 210 does not report the measurement result at the moment tᵣₑₚ, and discards an obtained incomplete measurement result.

Back to FIG. 5, in some implementations, the first communication apparatus 210 may select a preconfigured resource in the first reporting time window 506, to send the measurement result 524 to the second communication apparatus 220. In some implementations, the measurement result may include sensing information. For example, the first communication apparatus 210 may select, from the preconfigured resource, a resource that meets a sensing reporting delay requirement to report the sensing measurement result.

In some implementations, for example, to determine a dynamically indicated reporting resource 518 in the first reporting time window, the first communication apparatus 210 may send, to the second communication apparatus 220, a reporting condition corresponding to the first reporting time window 506. Correspondingly, the second communication apparatus 220 may receive, from the first communication apparatus 210, the reporting condition corresponding to the first reporting time window 506, and determine the first reporting time window 506 based on the reporting condition, to determine the reporting resource 518 in the first reporting time window 506.

For example, for different reporting conditions (for example, at least one of mobility of the first communication apparatus, a measurement environment, a type of the measurement result, and a value of the measurement result), the second communication apparatus 220 may configure a corresponding reporting delay window for the first communication apparatus 210. For example, the mobility of the first communication apparatus 210 may indicate a moving speed of the first communication apparatus 210. Compared with a static scenario, in a fast-moving scenario, a sensing result of the first communication apparatus 210 has a high timeliness requirement. For example, the second communication apparatus 220 may configure a first delay range for a static state of the first communication apparatus 210, configure a second delay range for a slow-moving state of the first communication apparatus 210, and configure a third delay range for a fast-moving state of the first communication apparatus 210. The second delay range may be greater than the third delay range and less than the first delay range. The measurement environment may indicate whether an environment in which the first communication apparatus 210 is located is a static environment or a dynamically changing environment, or whether an environment in which the first communication apparatus 210 is located is blocked. The type of the measurement result may indicate that the measurement result is, for example, a channel measurement result, an original sensing result, Doppler information, or specific location information (for example, a distance or an angle of a sensing measurement target). For example, the reporting condition may include the mobility of the first communication apparatus and the type of the measurement result. The second communication apparatus 220 may configure a fourth delay range for Doppler information in a high-speed moving scenario, and configure a fifth delay range for Doppler information in a low-speed moving scenario. The fourth delay range may be less than the fifth delay range. In addition, the second communication apparatus 220 may configure a sixth delay range for the channel measurement result, and configure a seventh delay range for the unprocessed original sensing result. The seventh delay range may be greater than the sixth delay range and greater than the fourth delay range. In addition, a value of the measurement result may indicate whether the measurement result exceeds a preset threshold. For example, the second communication apparatus 220 may configure an eighth delay range for a channel quality measurement result lower than the preset threshold, and configure a ninth delay range for a channel quality measurement result higher than the preset threshold. The eighth delay range may be less than the ninth delay range.

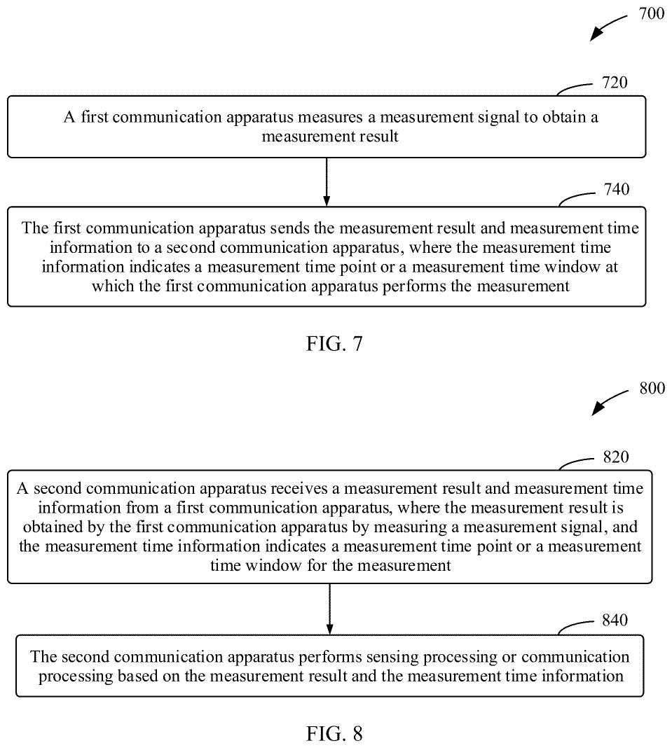

FIG. 7 is a schematic flowchart of a method 700 implemented by a first communication apparatus according to an embodiment of this application. In a possible implementation, the method 700 may be implemented by the first communication apparatus (terminal device) 210 in the example environment 200. In other possible implementations, the method 700 may also be implemented by another electronic apparatus independent of the example environment 200. As an example, the method 700 is described below by using an example in which the first communication apparatus 210 in the example environment 200 performs the method.

720: The first communication apparatus 210 measures a measurement signal to obtain a measurement result.

740: The first communication apparatus 210 sends the measurement result and measurement time information to a second communication apparatus 220, where the measurement time information indicates a measurement time point or a measurement time window at which the first communication apparatus 210 performs the measurement.

The method 700 may also be implemented by an example implementation of the method 300 as described above with reference to FIG. 3.

FIG. 8 is a schematic flowchart of a method 800 implemented by a second communication apparatus according to an embodiment of this application. In a possible implementation, the method 800 may be implemented by the second communication apparatus (network device) 220 in the example environment 200. In other possible implementations, the method 800 may also be implemented by another electronic apparatus independent of the example environment 200. As an example, the method 800 is described below by using an example in which the second communication apparatus 220 in the example environment 200 performs the method.

820: The second communication apparatus 220 receives a measurement result and measurement time information from a first communication apparatus 210, where the measurement result is obtained by the first communication apparatus 210 by measuring a measurement signal, and the measurement time information indicates a measurement time point or a measurement time window for the measurement.

840: The second communication apparatus performs sensing processing or communication processing based on the measurement result and the measurement time information.

The method 800 may also be implemented by an example implementation of the method 300 as described above with reference to FIG. 3.

In this manner, the first communication apparatus may report the measurement time information of the measurement result. Therefore, the second communication apparatus may determine a measurement moment corresponding to the measurement result, so that a measurement result with a time-domain correlation is obtained, and validity of the measurement result is improved, thereby helping the second communication apparatus obtain a more complete measurement result. This is particularly beneficial in a scenario in which the first communication apparatus determines a measurement moment by itself.

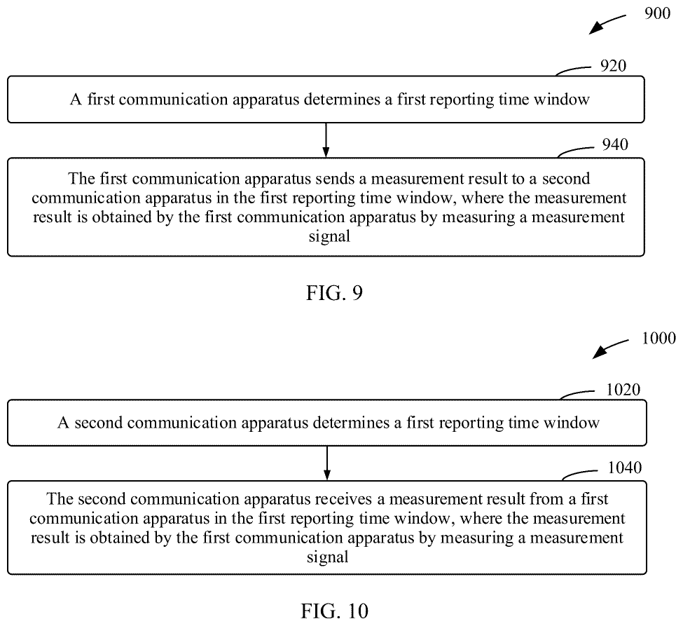

FIG. 9 is a schematic flowchart of a method 900 implemented by a first communication apparatus according to an embodiment of this application. In a possible implementation, the method 900 may be implemented by the first communication apparatus (terminal device) 210 in the example environment 200. In other possible implementations, the method 900 may also be implemented by another electronic apparatus independent of the example environment 200. As an example, the method 900 is described below by using an example in which the first communication apparatus 210 in the example environment 200 performs the method.

920: The first communication apparatus 210 determines a first reporting time window.

940: The first communication apparatus 210 sends a measurement result to the second communication apparatus 220 in the first reporting time window, where the measurement result is obtained by the first communication apparatus 210 by measuring a measurement signal.

The method 900 may also be implemented by an example implementation of the method 400 as described above with reference to FIG. 4.

FIG. 10 is a schematic flowchart of a method 1000 implemented by a second communication apparatus according to an embodiment of this application. In a possible implementation, the method 1000 may be implemented by the second communication apparatus (network device) 220 in the example environment 200. In other possible implementations, the method 1000 may also be implemented by another electronic apparatus independent of the example environment 200. As an example, the method 1000 is described below by using an example in which the second communication apparatus 220 in the example environment 200 performs the method.

1020: The second communication apparatus 220 determines a first reporting time window.

1040: The second communication apparatus 220 receives a measurement result from a first communication apparatus 210 in the first reporting time window, where the measurement result is obtained by the first communication apparatus 210 by measuring a measurement signal.

The method 1000 may also be implemented by an example implementation of the method 400 as described above with reference to FIG. 4.

In this manner, the first communication apparatus may use the reporting delay window when reporting the measurement result. Therefore, timeliness of the measurement result can be ensured, measurement result invalidity can be avoided, and validity of measurement effect can be improved. This is particularly beneficial in a scenario in which the first communication apparatus determines a measurement moment by itself. In some implementations, for different environment scenarios or different types of sensing results, the second communication apparatus configures different reporting delay windows for the first communication apparatus. In some implementations, the first communication apparatus indicates, to the second communication apparatus, the sensing reporting delay window determined by the first communication apparatus, to assist the second communication apparatus in determining the resource for reporting the measurement result. Auxiliary information from the second communication apparatus is used, so that timeliness of reporting the measurement result can be further enhanced, measurement result invalidity can be avoided, and validity of measurement effect can be improved.

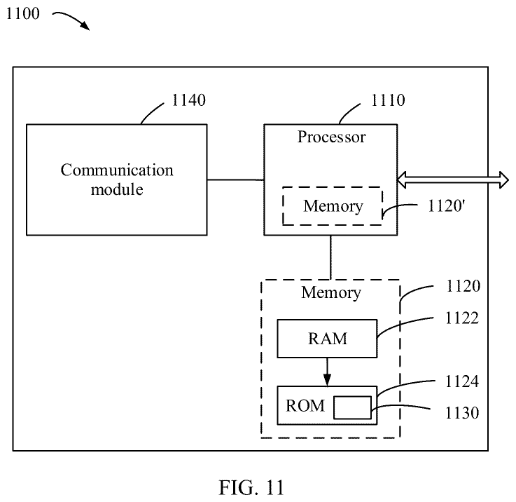

FIG. 11 is a block diagram of an example device 1100 that may be configured to implement an embodiment of this application. The device 1100 may be implemented as or include the first communication apparatus (terminal device) 210 or the second communication apparatus (network device) 220 in FIG. 2. As shown in the figure, the device 1100 may include one or more processors 1110 and a communication module 1140 coupled to the processor 1110. For example, the device 1100 may be coupled to one or more external memories (not shown). As another example, the device 1100 may further include one or more memories 1120 coupled to the processor 1110. In still another example, the processor 1110 may be integrated with one or more memories 1120′.

The communication module 1140 may be configured to perform bidirectional communication. The communication module 1140 may have at least one communication interface for communication. The communication interface may include any interface necessary for communicating with another device.

The processor 1110 may be any type applicable to a local technology network, and may include but is not limited to at least one of the following: one or more of a general-purpose computer, a dedicated computer, a microcontroller, a digital signal processor (Digital Signal Processor, DSP), or a controller-based multi-core controller architecture. The device 1100 may have a plurality of processors, such as an application-specific integrated circuit chip, which in time belongs to a clock synchronized with a main processor.

The memory 1120 may include one or more non-volatile memories and one or more volatile memories. An example of the non-volatile memory includes but is not limited to at least one of the following: a read-only memory (Read-Only Memory, ROM) 1124, an erasable programmable read-only memory (Erasable Programmable Read-Only Memory, EPROM), a flash memory, a hard disk, a compact disc (Compact Disc, CD), a digital versatile disc (Digital Versatile Disc, DVD), or other magnetic storage and/or optical storage. Examples of the volatile memory include but are not limited to at least one of the following: a random access memory (Random Access Memory, RAM) 1122, or another volatile memory that does not persist during power-off duration.

A computer program 1130 includes computer-executable instructions performed by an associated processor 1110. The program 1130 may be stored in the ROM 1124. The processor 1110 may perform any proper action and processing by loading the program 1130 into the RAM 1122.

Embodiments of this application may be implemented by using the program 1130, so that the device 1100 may perform any process discussed with reference to FIG. 2 to FIG. 10. Embodiments of this application may alternatively be implemented using hardware or a combination of software and hardware.

The program 1130 may be tangibly included in a computer-readable medium, and the computer-readable medium may be included in the device 1100 (for example, in the memory 1120) or another storage device that is accessible by the device 1100. The program 1130 may be loaded from the computer-readable medium into the RAM 1122 for execution. The computer-readable medium may include any type of tangible non-volatile memory, for example, a ROM, an EPROM, a flash memory, a hard disk, a CD, a DVD, or the like.

In some implementations, the communication module 1140 in the device 1100 may be implemented as a transmitter and a receiver (or a transceiver), and may be configured to send/receive information such as first spatial relation information and second spatial relation information. In addition, the device 1100 may further include one or more of the following: a scheduler, a controller, and a/an radio frequency/antenna. Details are not described in this application.

For example, the device 1100 in FIG. 11 may be implemented as an electronic device, or may be implemented as a chip or a chip system in an electronic device. This is not limited in embodiments of this application.

An embodiment of this application further provides a chip. The chip may include an input interface, an output interface, and a processing circuit. In this embodiment of this application, the input interface and the output interface may complete signaling or data interaction, and the processing circuit may complete generation and processing of signaling or data information. For example, a chip of the first communication apparatus 210 may generate, based on measurement performed by the first communication apparatus 210 on a measurement signal, a measurement result and measurement time information that indicates a measurement time point or a measurement time window for the measurement. A chip of the second communication apparatus 220 may perform sensing processing or communication processing based on the measurement result and the measurement time information that are received from the first communication apparatus 210. Optionally or additionally, the chip of the first communication apparatus 210 may determine a first reporting time window in which the measurement result is sent to the second communication apparatus 220. The chip of the second communication apparatus 220 may determine a first reporting time window in which the measurement result is received from the first communication apparatus 210.

An embodiment of this application further provides a chip system, including a processor, configured to support a computing device in implementing the function in any one of the foregoing embodiments. In a possible design, the chip system may further include a memory, configured to store necessary program instructions and data. When the processor runs the program instructions, a device in which the chip system is installed is enabled to implement the method in any one of the foregoing embodiments. For example, the chip system may include one or more chips, or may include a chip and another discrete device.

An embodiment of this application further provides a processor, configured to be coupled to a memory. The memory stores instructions. When the processor runs the instructions, the processor is enabled to perform the method and the function in any one of the foregoing embodiments.

An embodiment of this application further provides a computer program product including instructions. When the computer program product runs on a computer, the computer is enabled to perform the method and the function in any one of the foregoing embodiments.

An embodiment of this application further provides a computer-readable storage medium. The computer-readable storage medium stores computer instructions. When a processor runs the instructions, the processor is enabled to perform the method and the function in any one of the foregoing embodiments.

Usually, various embodiments of this application may be implemented by hardware or a dedicated circuit, software, logic, or any combination thereof. Some aspects may be implemented by hardware, and other aspects may be implemented by firmware or software, and may be executed by a controller, a microprocessor, or another computing device. Although various aspects of embodiments of this application are shown and described as block diagrams or flowcharts, or represented by some other illustrations, it should be understood that the blocks, apparatuses, systems, technologies, or methods described in this specification may be implemented as, for example, non-limiting examples: hardware, software, firmware, dedicated circuits or logic, general-purpose hardware, controllers, other computing devices, or a combination thereof.

This application further provides at least one computer program product tangibly stored on a non-transitory computer-readable storage medium. The computer program product includes computer-executable instructions, such as instructions included in a program module, which are executed in a device on a real or virtual target processor to perform the process/method as described above with reference to the accompanying drawings. Usually, the program module includes a routine, a program, a library, an object, a class, a component, a data structure, or the like that executes a specific task or implements a specific abstract data type. In various embodiments, functions of the program modules may be combined or split between the program modules as required. Machine-executable instructions for the program module may be executed locally or in a distributed device. In the distributed device, the program module may be locally located and located in a remote storage medium.

Computer program code for implementing the method in this application may be written in one or more programming languages. The computer program code may be provided for a processor of a general-purpose computer, a dedicated computer, or another programmable data processing apparatus, so that when the program code is executed by the computer or the another programmable data processing apparatus, functions/operations specified in the flowcharts and/or block diagrams are implemented. The program code may be executed entirely on a computer, partly on a computer, as a standalone software package, partly on a computer and partly on a remote computer, or entirely on a remote computer or a server.

In the context of this application, the computer program code or related data may be carried in any proper carrier, so that the device, the apparatus, or the processor can perform various processing and operations described above. Examples of the carrier include a signal, a computer-readable medium, and the like. Examples of the signal may include an electrical signal, an optical signal, a radio signal, a voice signal, or other forms of propagated signals, such as a carrier wave and an infrared signal.

The computer-readable medium may be any tangible medium that includes or stores programs used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus or device, or any suitable combination thereof. More detailed examples of the computer-readable storage medium include an electrical connection with one or more wires, a portable computer disk, a hard disk, a random access memory (RAM), a read-only memory (ROM), an erasable programmable read-only memory (EPROM or a flash memory), an optical storage device, a magnetic storage device, or any suitable combination thereof.

In addition, although the operations of the methods in this application are described in a particular order in the accompanying drawings, this does not require or imply that these operations need to be performed in the particular order or that all of the shown operations need to be performed to achieve a desired result. Instead, execution orders of the steps depicted in the flowcharts may change. Additionally or alternatively, some steps may be omitted, a plurality of steps may be combined into one step for execution, and/or one step may be broken down into a plurality of steps for execution. It should further be noted that features and functions of two or more apparatuses according to this application may be specific in one apparatus. Instead, features and functions of one apparatus described above may be further specific in a plurality of apparatuses.

The foregoing has described the implementations of this application. The foregoing descriptions are examples, are not exhaustive, and are not limited to the disclosed implementations. Without departing from the scope of the described implementations, many modifications and variations are apparent to a person of ordinary skill in the art. Selection of the terms used in this specification is intended to well explain principles of the implementations, actual applications, or improvements to technologies in the market, or to enable another person of ordinary skill in the art to understand the implementations disclosed in this specification.

What is claimed is:

1. A communication method, comprising:
measuring, by a first communication apparatus, a measurement signal to obtain a measurement result; and
sending, by the first communication apparatus, the measurement result and measurement time information to a second communication apparatus, wherein the measurement time information indicates a measurement time point or a measurement time window at which the first communication apparatus performs the measurement.

2. The method according to claim 1, wherein the measurement time information comprises at least one of a system frame number, a slot index, a mini-slot index, and a symbol index that correspond to the measurement time point.

3. The method according to claim 1, wherein the measurement time information comprises a time domain offset, and the time domain offset indicates a time interval between the measurement time point and a reference time point or a time interval between the measurement time window and a reference time point.

4. The method according to claim 3, wherein the reference time point is a time point at which the first communication apparatus sends the measurement result or a time point at which the first communication apparatus sends the measurement time information.

5. The method according to claim 1, wherein
the measurement time information indicates the measurement time point based on an index of the measurement signal.

6. The method according to claim 5, wherein the index of the measurement signal comprises at least one of the following:
a window index, indicating a measurement signal window in which the measurement signal is located;
a type index, indicating a type of the measurement signal; and
a signal index, indicating a measurement signal in the measurement signal window in which the measurement signal is located or indicating a measurement signal of the type of the measurement signal or a signal in measurement signals in a predetermined time period.

7. The method according to claim 1, wherein the measurement time information comprises at least one of a start time point, an end time point, duration of the measurement time window, or an index of the measurement time window.

8. A communication method, comprising:
receiving, by a second communication apparatus, a measurement result and measurement time information from a first communication apparatus, wherein the measurement result is obtained by the first communication apparatus by measuring a measurement signal, and the measurement time information indicates a measurement time point or a measurement time window for the measurement; and
performing, by the second communication apparatus, sensing processing or communication processing based on the measurement result and the measurement time information.

9. The method according to claim 8, wherein the measurement time information comprises at least one of a system frame number, a slot index, a mini-slot index, and a symbol index that correspond to the measurement time point.

10. The method according to claim 8, wherein the measurement time information comprises a time domain offset, and the time domain offset indicates a time interval between the measurement time point and a reference time point or a time interval between the measurement time window and a reference time point.

11. The method according to claim 10, wherein the reference time point is a time point at which the first communication apparatus sends the measurement result or a time point at which the first communication apparatus sends the measurement time information.

12. The method according to claim 8, wherein
the measurement time information indicates the measurement time point based on an index of the measurement signal.

13. The method according to claim 12, wherein the index of the measurement signal comprises at least one of the following:
a window index, indicating a measurement signal window in which the measurement signal is located;
a type index, indicating a type of the measurement signal; and
a signal index, indicating a measurement signal in the measurement signal window in which the measurement signal is located or indicating a measurement signal of the type of the measurement signal or a signal in measurement signals in a predetermined time period.

14. The method according to claim 8, wherein the measurement time information comprises at least one of a start time point, an end time point, duration of the measurement time window, or an index of the measurement time window.

15. A communication method, comprising:
determining, by a first communication apparatus, a first reporting time window; and
sending, by the first communication apparatus, a measurement result to a second communication apparatus in the first reporting time window, wherein the measurement result is obtained by the first communication apparatus by measuring a measurement signal.

16. The method according to claim 15, further comprising:
sending, by the first communication apparatus, the first reporting time window to the second communication apparatus, wherein the first reporting time window is comprised in a buffer status report.

17. The method according to claim 15, wherein
the first reporting time window comprises at least one of a start time point, an end time point, and duration, wherein the start time point is a time point at which the first communication apparatus performs the measurement or a time point at which the first communication apparatus sends the first reporting time window.

18. The method according to claim 15, further comprising:
receiving, by the first communication apparatus from the second communication apparatus, a resource for sending the measurement result, wherein the resource is in the first reporting time window; and/or
sending, by the first communication apparatus, the measurement result to the second communication apparatus on a preconfigured resource in the first reporting time window.

19. The method according to claim 15, wherein the determining, by a first communication apparatus, a first reporting time window comprises:
receiving, by the first communication apparatus, one or more reporting time windows from the second communication apparatus, wherein the one or more reporting time windows comprise the first reporting time window; and
determining, by the first communication apparatus, the first reporting time window from the one or more reporting time windows.

20. The method according to claim 15, further comprising:
sending, by the first communication apparatus, a reporting condition of the first reporting time window to the second communication apparatus, wherein the reporting condition comprises at least one of the following:
mobility of the first communication apparatus, a measurement environment, a type of the measurement result, and a value of the measurement result.
